(19) United States
(12) Patent Application Publication
(10) Pub. No.: US 2019/0114726 A1
(43) Pub. Date: Apr. 18, 2019

(54) Rental Real Estate Information Sharing System and Method

(71) Applicant: BI:RADIX, L.L.C., Scottsdale, AZ (US)

(72) Inventor: Blerim Z. Zeqiri, Scottsdale, AZ (US)

(73) Assignee: BI:RADIX, L.L.C., Scottsdale, AZ (US)

(21) Appl. No.: 16/158,018

(22) Filed: Oct. 11, 2018

Related U.S. Application Data
(60) Provisional application No. 62/573,621, filed on Oct. 17, 2017.

(51) Int. Cl. G06Q 50/16; G06Q 30/06

(52) U.S. Cl. CPC G06Q 50/16; G06Q 30/0623

(57) ABSTRACT

An electronic network is provided to facilitate an exchange of information. A database on a first computing system provides a data structure to organize records for the exchange of information. First property information from a first user on a second computing system is provided to an electronic information exchange agent for storage in the data structure on the first computing system. Second property information from a second user on a third computing system is provided to the electronic information exchange agent for storage in the data structure on the first computing system. The first user and second user are competitors. The first property information and second property information include confidential property information. The first property information and the second property information are exchanged between the first user and second user through the electronic information exchange agent. A report is generated from the first property information or second property information.

### CLAIM OF DOMESTIC PRIORITY

The present application claims the benefit of U.S. Provisional Application No. 62/573,621, filed Oct. 17, 2017, which application is incorporated herein by reference.

### FIELD OF THE INVENTION

The present invention relates in general to an enhanced computer system and, more particularly, to information sharing and exchange through the enhanced computer system.

### BACKGROUND OF THE INVENTION

A computer system provides an opportunity to share and exchange information. The availability and access to information continue to expand with higher bandwidth internet, more storage space, mobile devices, and faster computing platforms. People routinely need comparative data for their business and often turn to a computer to find the requisite information. Consider a situation where a user is seeking information on real estate, e.g., residential rental information for a geographical area. The internet has many websites dedicated to real estate sales and rentals, e.g., Zillow.com, Trulia.com, Rent.com, Homes.com, Craigslist.com, and Apatments.com. The websites contain information on units, location, features, amenities, pricing, incentives, and lease terms. For example, a residential unit is 1500 square feet and located at a given address, with two bedrooms, two baths, private patio, and two-car garage. The unit is unfurnished, tile floors, no pets, community pool, and the local schools are provided. The rental price and incentives are given with other leasing terms. All rental information is entered by the listing agent or owner to one or more of the above websites and is searchable to interested parties.

The listing agent or owner collects the rental information from a variety of sources, i.e., architectural plans, personal and public records, survey of the unit and surrounding area, maps, financial and loan records, tax records, homeowner association records, and competitive analysis. The listing agent or owner determines rental pricing based on a number of factors, including cost of ownership, return on investment, competitive market analysis, and other financial indicators. The agent or owner posts the listing on one or more of the above websites with features, amenities, and market pricing, as best can be determined at the time.

The competitive market analysis is often a difficult parameter to determine. The listing agent or owner can perform internet searches looking for similar properties and locations to understand the competitive market. The above-described 1500 square foot unit may rent for a wide range of values depending on location, upgrades, amenities, and market conditions. Much of the competitive information is difficult and time-consuming to search for and collect. The competitive information is often dynamic and can change at anytime. Pricing fluctuates, new incentives are offered, units become available and others lease, new ownership changes strategies, and market conditions are up and down. What was accurate and relevant this week may be old news next week. The searches for competitive information are routinely repeated due to the limited shelf life of the information. Other competitive factors, such as prospective tenant traffic, lease terms, lease percentage (units with leases), and occupancy rates, are often considered confidential and unpublished.

For listing agents or owners with large rental inventories and mega complexes of multi-family units, the competitive analysis search and data collection process is inefficient and consumes excessive computing and networking resources. The listing agent or owner typically works with limited and dated competitive information and makes best guess at rental pricing and incentives in view of the market conditions.

### BRIEF DESCRIPTION OF THE DRAWINGS

FIG. 1 illustrates an electronic information exchange agent handling information exchange between users;

FIG. 2 illustrates a data structure for the information exchange transaction;

FIG. 3 illustrates an electronic communication network connecting users and devices;

FIG. 4 illustrates computer systems operating on the electronic communication network;

FIG. 5 illustrates an account and profile webpage for users to set up with the electronic information exchange agent;

FIG. 6 illustrates a home webpage for users to interact with the information exchange agent;

FIG. 7 illustrates a webpage for managing property information;

FIG. 8 illustrates a list of property information with users authorized to access the information;

FIG. 9 illustrates a manual information exchange transaction;

FIG. 10 illustrates an automated information exchange transaction;

FIG. 11 illustrates users exchanging property information through the information exchange agent;

FIG. 12 illustrates a webpage showing user comps from the exchanged property information;

FIG. 13 illustrates a report of competitive analysis from the exchanged property information;

FIG. 14 illustrates a webpage to select property information for a report;

FIG. 15 illustrates another webpage to select property information for a report;

FIG. 16 illustrates a report of pricing over time from the exchanged property information;

FIG. 17 illustrates a report of occupancy over time from the exchanged property information;

FIG. 18 illustrates a report of leases over time from the exchanged property information; and

FIG. 19 illustrates a webpage showing error detecting for a report.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

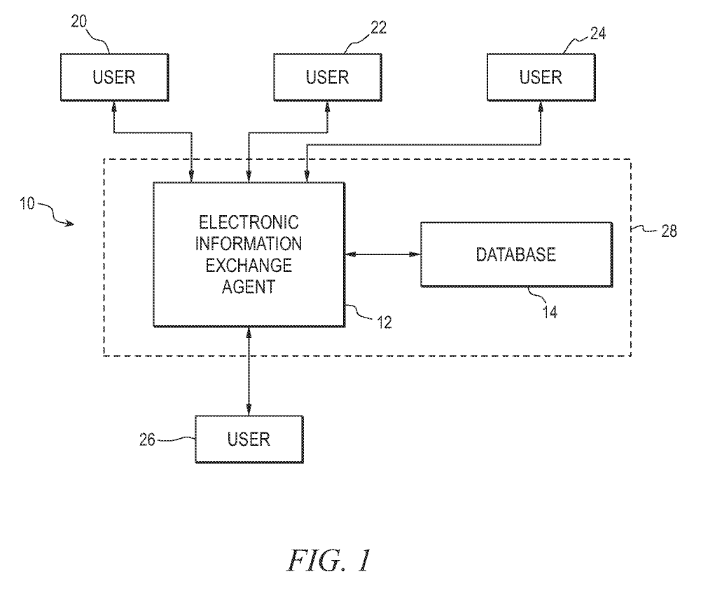

People regularly engage in the business of rental property. Owners have rental property to offer for lease and renters search for housing to lease. FIG. 1 shows an enhanced computer system 10 with electronic information exchange agent 12 maintaining database 14. Database 14 is a mass storage system, e.g., server mass storage, with a data structure and record organization optimized for the exchange of information between users. User 20 is a listing agent or owner with rental property to offer for lease. Likewise, user 22 and 24 are each independent listing agents or owners with rental property to offer for lease. User 26 is a renter in need of a rental property to lease. Users 20-24 are considered competitors among themselves, each with property that may be of interest to user 26. Electronic information exchange agent 12 functions as an organizer and facilitator between users 20-24 to collect, organize, analyze, disperse, exchange, share, and report rental property information provided by users 20-24 using database 14 on electronic information exchange platform 28 executing on computer system 10. User 26 may also make use of the rental property information, as provided by users 20-24, on electronic information exchange platform 28.

The continuing flow of accurate and useful rental property information between users 20-24 is a principal way to efficiently obtain competitive analysis. A computer system provides an opportunity to share and exchange information. The availability and access to information continue to expand with higher bandwidth internet, more storage space, mobile devices, and faster computing platforms. The enhanced computer system with associated data and organizational structures monitors and regulates the connection between users 20-24 seeking to exchange and share information. One user would offer their own rental property information, including information that would otherwise be considered confidential, to another user in exchange or reciprocation of similar information, referred to as an information exchange transaction. If the users agree, the competitive information is exchanged or shared between competitors, indirectly through electronic information exchange agent 12.

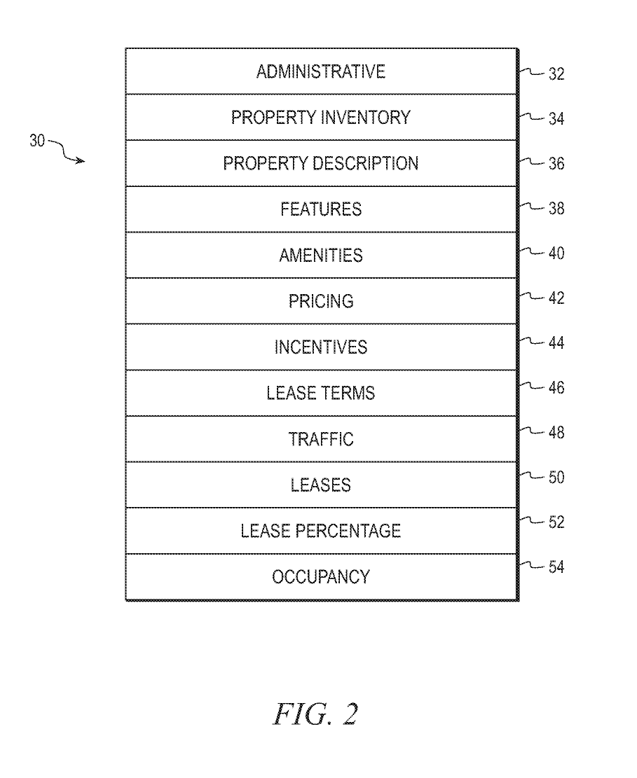

Electronic information exchange agent 12 maintains unique data structure 30 in database 14, as shown in FIG. 2, to facilitate and optimize the information exchange transaction between users 20-24 to enhance the function, operation, and efficiency of computer system 10. There can be one or more data records in data structure 30 per information exchange transaction. Multiple exchanges between users 20-24 can create multiple data records in data structure 30. For example, a first data record involves a first offer and response to information exchange, a second data record involves a second offer and response to information exchange, and so on.

Data structure 30 includes administrative field 32 for tracking information related to users 20-24, such as name, address, email, phone, contact persons by area of responsibility, and identified or acknowledged competitors. Property inventory field 34 includes name(s) and location(s) of rental property inventory and number of units per location. Property inventory can be the Casa Norte multi-family complex at a given address with 200 rental units. Property description field 36 includes unit name, unit number, floorplan, unit style, or square footage within the property inventory. A property description can be unit 12B with the 1250 square foot Regent floorplan including living room, kitchen, dining room, two bedrooms, two baths, and walk-in closet at the Casa Norte multi-family complex. Features field 38 includes features associated with a particular floorplan, unit style, unit name, or square footage within the property inventory. Features can be private patio, ground-level access, covered parking or garage, stainless steel appliances, tile floors, fireplace, and park view associated with the particular Regent 1250 square foot floorplan at the Casa Norte multi-family complex. Amenities field 40 includes amenities associated with the property inventory, such as community pool, community exercise room, common areas, retail access, local school system, clubhouse, public parks, lakes, golf course, visibility, walkability, public transportation, pet-friendly or no pets depending on preference, and quiet times associated with the Casa Norte multi-family complex. Pricing field 42 includes pricing for a particular unit within the property inventory. Incentives field 44 includes incentives for one or more units within the property inventory. Incentives include free or reduced rental pricing for limited time during long-term lease, offer for fresh paint, offer to upgrade flooring, option to change units when a more desirable unit becomes available, and other discounts. Leasing terms field 46 includes terms and conditions of the lease, such as length of lease, renewal options, security deposit, termination, subleasing, premises liability, maintenance and repairs, pets, and offensive behavior. Traffic field 48 includes occurrence, frequency, date, and times of prospective tenants stopping by, touring, or otherwise inquiring about one or more units within the property inventory. Leases field 50 includes a number of leases executed within a time period. Lease percentage field 52 includes a percentage of units leased. Occupancy field 54 includes a percentage of units within all or a portion of the property inventory that are occupied.

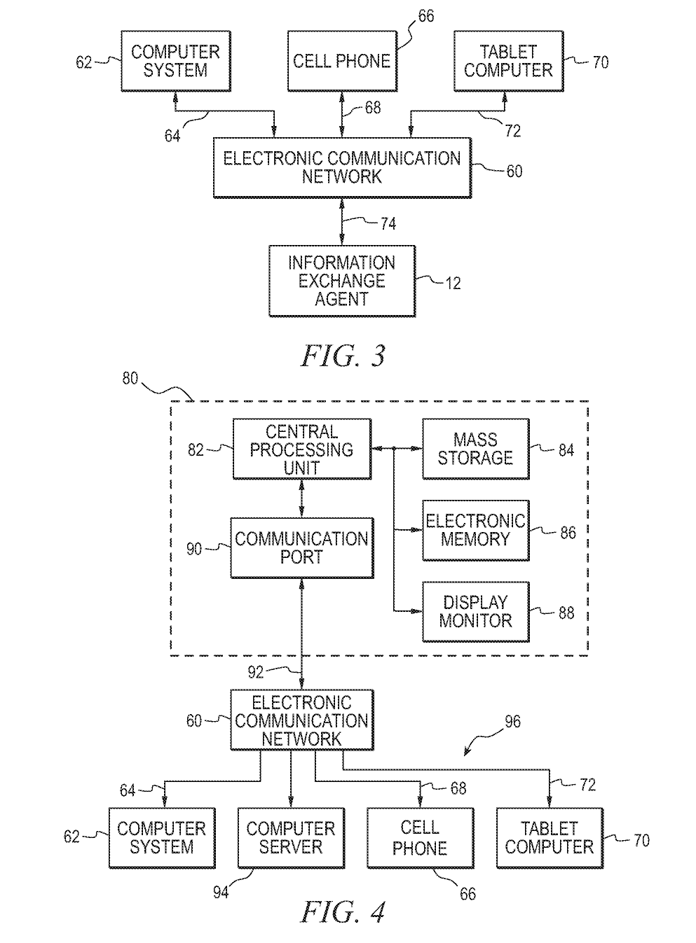

FIG. 3 shows an electronic communication network 60 for transmitting information between users 20-24 using one or more of computer system 62, cell phone 66, or tablet computer 70 to access electronic information exchange agent 12. Computer system 62 is connected to electronic communication network 60 by way of communication channel or link 64. Likewise, cellular telephone or smartphone 66 connects to electronic communication network 60 via communication link 68 and tablet computer 70 is connected to electronic communication network 60 by way of communication channel or link 72. Information exchange agent 12 operating on a computer server communicates with electronic communication network 60 over communication channel or link 74.

The electronic communication network 60 is a distributed network of interconnected routers, gateways, switches, and servers, each with a unique internet protocol (IP) address to enable communication between individual computers, cellular telephones, tablets, electronic devices, or nodes within the network. In one embodiment, communication network 60 is a global, open-architecture network, commonly known as the internet. In other embodiments, electronic communication network 60 includes a cell phone service network. Communication channels 64, 68, 72, and 74 are bi-directional and transmit data between computer system 62, cell phone 66, tablet computer 70, information exchange agent 12, and electronic communication network 60 in a hard-wired or wireless configuration. For example, computer system 62 has email, audio/video, and web browsing capability, and consumer cell phone 66 and tablet computer 70 have email, mobile applications (apps), audio/video, texting, and web browsing capability.

Further detail of the computer systems used in electronic communication network 60 is shown in FIG. 4 as a simplified computer system 80 for executing software programs used in the electronic communication process. Computer system 80 is a general-purpose computer including a central processing unit (CPU) or microprocessor 82, mass storage device or hard disk 84, electronic memory or RAM 86, display monitor 88, and communication port 90. Data records in data structure 30 can be stored in mass storage device 84 and/or electronic memory 86 and organized to facilitate and optimize the information exchange transaction between users 20-24 and enhance the functionality, operation, and efficiency of computer system 10. Communication port 90 represents a modem, high-speed Ethernet link, wireless, or other electronic connection to transmit and receive data over communication link 92 to electronic communication network 60. Computer system 62 and computer server 94 are configured similar to, and include similar internal components as, computer 80. Cell phone 66 and tablet 70 include related components as computer system 80, although commonly run different operating systems, software, and include smaller parts and packaging. Computer systems 62 and 80, computer server 94, cell phone 66, and tablet computer 70 (collectively referenced as devices 96) transmit and receive information and data over electronic communication network 60.

Devices 96 are physically located in any location with access to a modem or communication link to network 60. For example, devices 96 are located in a home or business office, a facility of information exchange agent 12, or are mobile and accompany the user to any convenient location, e.g., remote offices, consumer locations, hotel rooms, residences, vehicles, public places, or other locales with wired or wireless access to electronic communication network 60. Some devices 96 are carried with the individuals and operate with mobile apps.

Devices 96 run application software and computer programs, which are used to display user interface screens, execute the functionality, and provide the electronic communication features as described herein. The application software includes an internet browser, local email application, mobile apps, word processor, spreadsheet, audio/video feature, application programming interface (API), and the like. In one embodiment, the screens and functionality come from the application software, i.e., the electronic communication runs directly on devices 96. Alternatively, the screens and functions are provided remotely from one or more websites and webpages on servers connected to electronic communication network 60.

In one embodiment, electronic information exchange agent 12 includes an API accessed by users 20-24. Users 20-24 enter data directly using the API, or through websites and applications connected to electronic information exchange agent 12 via the API. An API facilitates the request and retrieval of information on behalf of a software program or application. An API is a set of commands, functions, and protocols, which programmers or developers use when building software for a specific operating system or application. An API allows programmers to use predefined functions to interact with an external application or computer system.

An API allows a software application to communicate with other applications running on a remote server over the internet using a series of API calls. With APIs, calls back and forth between applications are managed through web services. Web services are a collection of technological standards and protocols, including XML (Extensible Markup Language), a programming language by which applications communicate over the internet. An API call can comprise software code written as a series of XML messages. Each XML message corresponds to a different function of the remote service. For example, in a conferencing API, there are XML messages that correspond to each element required to schedule a new Web conference. Those elements include the conference time, the organizer's name and contact information, the invitees, and the duration of the conference.

An API can grant access to or open an application as an interface, defining the way in which separate entities or applications communicate. In some cases, software developers analogize APIs as “doors”, or “gateways,” that enable communication between different applications. APIs provide flexible yet controlled access to the data of an external computer system. The value of existing programs can be multiplied because content of the existing applications can be re-used, accessed, or exploited using APIs. Users 20-24 communicate with a web browser plugin connected to electronic information exchange agent 12 via an API to allow interaction between the users.

The software is originally provided on computer readable media, such as compact disks (CDs), digital versatile disks (DVDs), flash drives, and other optical media or mass storage medium. Alternatively, the software is downloaded electronically, such as from a host or vendor website. The software is installed onto the computer system mass storage 84 and/or electronic memory 86, and is accessed and controlled by the computer operating system. Software updates are also available on mass storage medium or downloadable from the host or vendor website. The software, as provided on the computer readable media or downloaded from electronic links, represents a computer program product containing computer readable program code embodied in a non-transitory computer program medium. Devices 96 execute instructions of the application software utilizing data structure 30 for communication between users 20-24 and electronic information exchange agent 12 to enable and administrate the exchange of information. Cell phone 66 or tablet computer 70 runs one or more mobile apps to execute instructions for communication between users 20-24 and electronic information exchange agent 12, which enables and administrates the exchange of information. The application software is an integral part of the control of electronic information exchange activity within enhanced computer system 10.

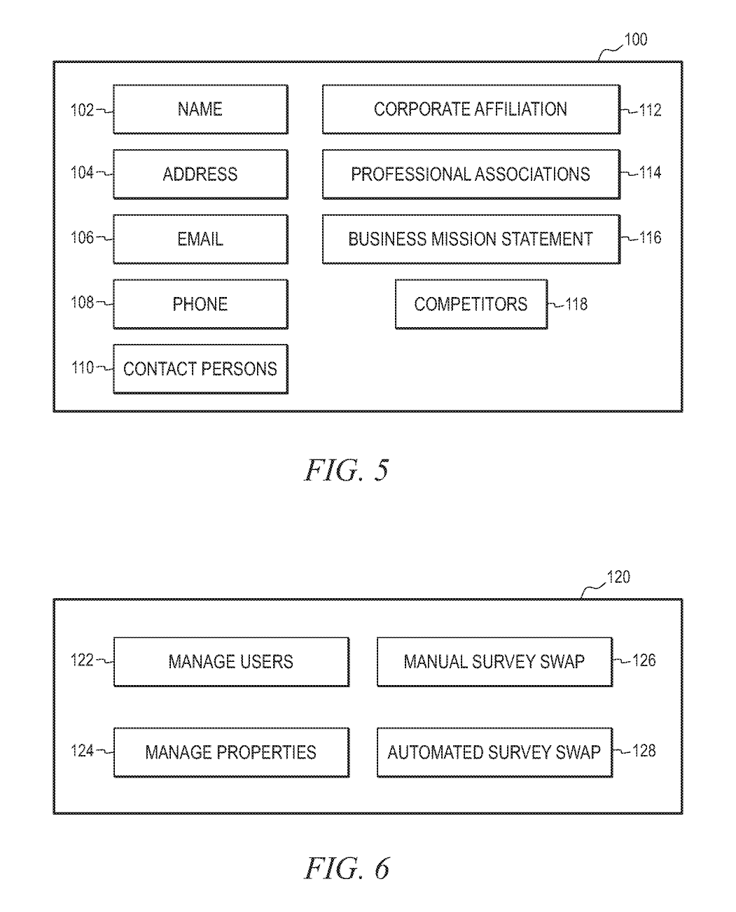

To interact with electronic information exchange agent 12, user 20-24 creates an account and profile with the information exchange agent. Full access requires completion of a registration process. User 20-24 accesses webpage 100 operated by information exchange agent 12 on electronic information exchange platform 28 and provides data to complete the registration and activation process, as shown in FIG. 5. The data provided by user 20-24 to electronic information exchange agent 12 includes name in block 102, address in block 104, email address in block 106, phone number in block 108, contact persons in block 110, corporate affiliation in block 112, professional associations in block 114, business mission statement in block 116, known competitors in block 118, and other information necessary to establish a profile and identity for the user. For example, user 20 may identify users 22 and 24 as known competitors in block 118, i.e., users define their competitors. The competitive designation may or may not be reciprocal. Electronic information exchange agent 12 can suggest competitors to users 20-24. User 20-24 agrees to the terms and conditions of conducting electronic communication through information exchange agent 12.

Once user 20-24 has logged-in to electronic information exchange agent 12, the user is presented with a home page to launch a variety of operations and functions using one or more webpages, menus, and features to facilitate the exchange of information between the users. FIG. 6 illustrates users 20-24 in communication with information exchange agent 12 on electronic information exchange platform 28 by electronic network 60 using devices 96 to access home webpage 120 with functions of manage users 122, manage properties 124, manual survey swap 126, and automated survey swap 128. The user interface and layout of the webpages described herein can take a variety of forms. For example, the functions of webpage 120 can be presented as pull-down menus across the top or side of the webpage. The following simplified webpages are presented to illustrate the function and operation of information exchange agent 12 on electronic information exchange platform 28.

The user's profile is stored and maintained within database 14. User 20-24 can access and update his or her profile or interact with electronic information exchange agent 12. Manage users 122 allows users 20-24 to add, modify, and delete users and profile information with webpage 100. Users 20-24 can change passwords, set notification preferences, communicate directly with information exchange agent 12, and assign users to properties. The user's profile and personal data remains secure and, where appropriate, confidential within electronic information exchange agent 12.

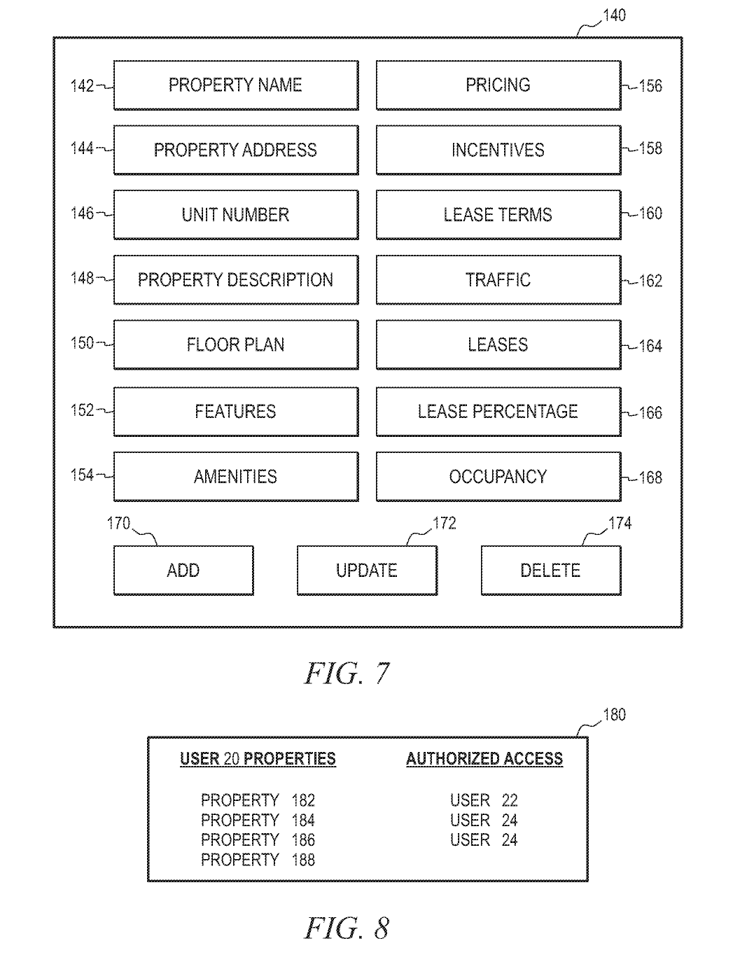

Webpage 140 in FIG. 7 illustrates implementation of manage properties 124. To add a specific property, user 20 enters rental data and information for the property. Property name is provided in block 142, property address in block 144, unit number in block 146, property description in block 148, floorplan in block 150, features in block 152, amenities in block 154, pricing in block 156, incentives in block 158, lease terms in block 160, traffic in block 162, leases in block 164, lease percentage in block 166, and occupancy in block 168. For example, unit 12B at the Casa Norte multi-family complex is entered into blocks 142-168. Unit 12B is a 1250 square foot Regent floorplan including living room, kitchen, dining room, two bedrooms, two baths, and walk-in closet. Unit 12B has features including private patio, ground-level access, covered parking, stainless steel appliances, tile floors, fireplace, and park view. Unit 12B has amenities including a community pool, community exercise room, common areas with volleyball, retail stores with walking distance, school system, clubhouse, public park nearby, no pets, public transportation, and quiet times 10 pm to 6 am. Unit 12B is $1200 per month with incentives of 50% discount off first month with 12 month lease. Unit 12B has leasing terms of 12 month lease with first renewal at same pricing and $250 security deposit. Casa Norte complex has traffic of 49 prospective tenants in the last 30 days, with 70% of the traffic on the weekends and 30% on the weekdays. Peak traffic times are 11 am-2 pm. Casa Norte complex has executed 5 new leases in the last 30 days, giving a lease percentage of 93.0% and occupancy of 91.4%. User 20 clicks on add button 170 to add the property information into fields 32-54 of data structure 30 in database 14 of electronic information exchange platform 28. User 20 enters multiple properties from multiple locations into fields 32-54 of data structure 30 in database 14 of electronic information exchange platform 28 using webpage 140. User 20 can set up floorplan templates to standardize and simplify data entry. A template would automatically add features, amenities, pricing, incentives, lease terms, and other property information common to the floorplan. User 20 can update the property information with update button 172, or delete the property information with delete button 174. Users 22 and 24 can also add, update, and delete property information using webpage 140.

Webpage 180 in FIG. 8 shows individual properties of user 20 in database 14. User 20 can scroll through properties 182-188 to review, report, modify, delete, and otherwise manage the listed properties. Users 22-24 can review their individual properties in a similar webpage 180.

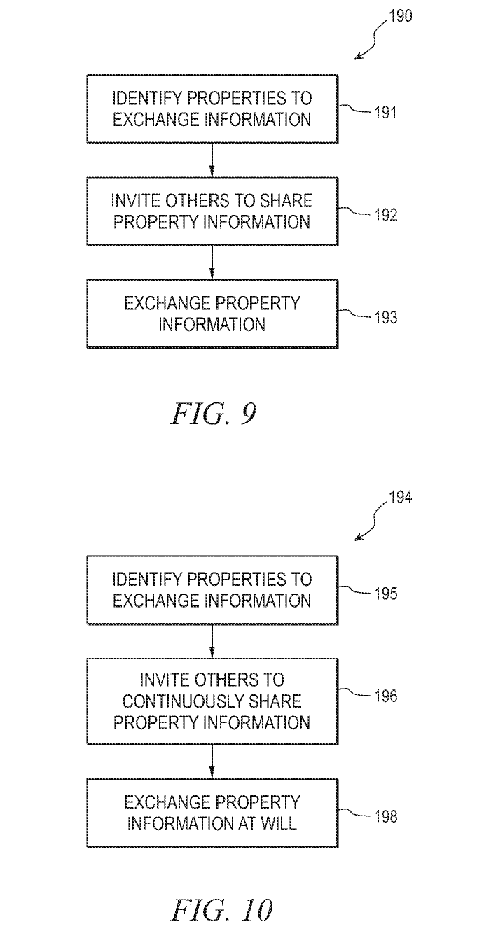

User 20 is interested in exchanging and sharing property information with user 22 and/or user 24. User 20 has identified user 22 and user 24 as owning or managing properties similar to one or more of properties 182-188, i.e., users 22-24 are competitors of user 20. User 20 selects manual survey swap 126 in FIG. 6 to send a request or invitation through information exchange agent 12 to user 22 and/or user 24 to complete a market survey (manual survey swap). FIG. 9 shows the steps of information exchange transaction 190. In step 191, user 20 identifies one or more of properties 182-188 that he or she is willing to share the property information, including information that would otherwise be considered confidential and unavailable to competitors. For example, user 20 identifies all units at Casa Norte in the manual survey swap. User 22 has a property Augustus similar to Casa Norte. In step 192, user 20 invites user 22 to share the Augustus property information in exchange for the Casa Norte property information. User 22 enters property information for all units at Augustus using webpage 140, or otherwise makes available to user 20 property information for Augustus that has already been entered. In step 193, once user 22 makes Augustus property information available to user 20, then user 22 can view Casa Norte property information. Users 20 and 22 have exchanged property information, including confidential property information (manual survey swap). Users 20 and 22 can use the exchanged property information to conduct competitive analysis and run reports to better understand the total market. Electronic information exchange agent 12 controls information exchange transaction 190 to ensure integrity of the exchange. If information exchange agent 12 determines that there are other properties relevant or similar to what user 20 has selected (user 22 properties), then users 20 and 22 get these other properties as well. Information exchange agent 12 uses a number of factors, such as proximity, reciprocal comp, and update timing, to determine relevancy of additional comps for consideration. The same exchange can occur between user 20 and user 24, and between user 22 and user 24.

The exchange of business information between competitors, even confidential information, has a number of advantages. Each user 20-24 makes use of competitor property information in setting their own pricing, amenities, incentives, and leasing terms. Competition is understood to be helpful to the overall market so sharing information maintains equality and stabilizes the market. No one user 20-24 can dominate the market. Market domination often results in an inferior market, robust competition usually provides a superior market. Tenants benefit from the competitive market. Users 20-24 can stay relevant in the marketplace by maintaining par with the competition. Competitive investigation and analysis occurs anyway, often with inaccurate information and inefficient and excessive use of computing and network resources. Electronic information exchange platform 28 facilitates the exchange and sharing of property information between competitors with efficient use of computing and network resources in a shared eco-system. Users 20-24 can provide and review accurate, timely, and relevant property information across the market.

Once users 20-24 become accustom to sharing information, then properties can be identified with users having continuing authorized access to conduct automated survey swapping. FIG. 10 shows the steps of automated information exchange transaction 194. In step 195, user 20 identifies one or more of properties 182-188 that he or she is willing to continuously share the property information, which contains information that would otherwise be considered confidential and unavailable to competitors. User 22 has a property Augustus similar to Casa Norte. In step 196, user 20 invites user 22 to continuously share the Augustus property information in exchange for the Casa Norte property information. In step 198, once user 20 and user 22 agree to the continuous exchange, then each can view the other users property information at will. Users 20 and 22 can use the exchanged property information to conduct competitive analysis and run reports to better understand the total market.

In webpage 180, user 22 has continuing access to property 182 of user 20, and user 24 has continuing access to property 184 of user 20. Users 20-24 agree to maintain current property information to be shared at will. Information exchange agent 12 monitors property information to confirm up-to-date content. Failure to maintain property information results in warning to update and then removal of authorized access.

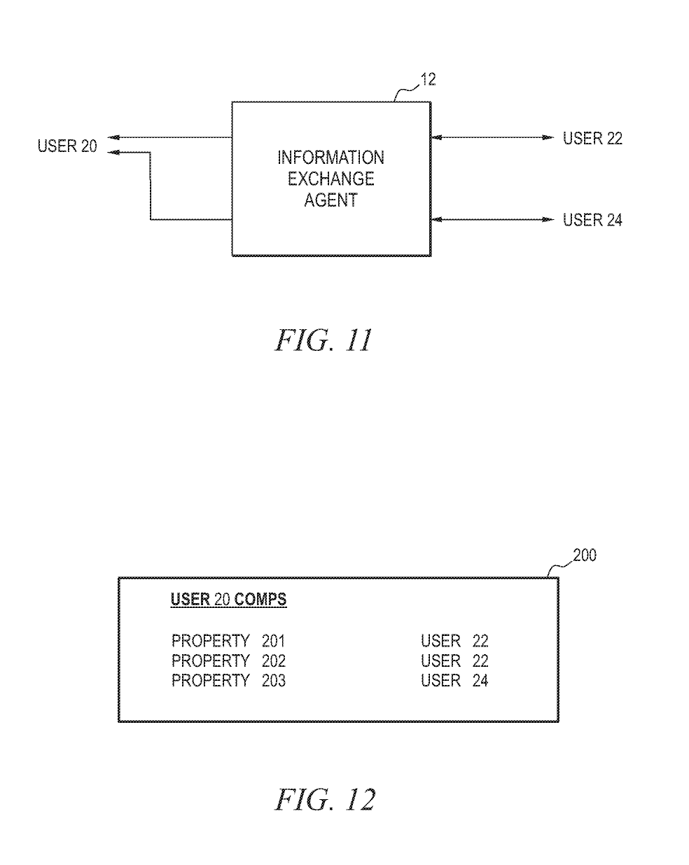

FIG. 11 illustrates users 20 and 22 exchanging property information through information exchange agent 12, using either manual survey swap or automated survey swap. Likewise, users 20 and 24 exchange property information through information exchange agent 12.

Webpage 200 in FIG. 12 shows comparative properties (comps) of user 20. User 20 has identified and added property 201 owned by user 22, property 202 owned by user 22, and property 203 owned by user 24, as relevant and reliable comps for one or more properties 182-188. User 20 utilizes comps (properties 201-203) for competitive analysis. User 20 can scroll through properties 201-203 to review, report, prioritize, add, delete, and otherwise manage the listed comps.

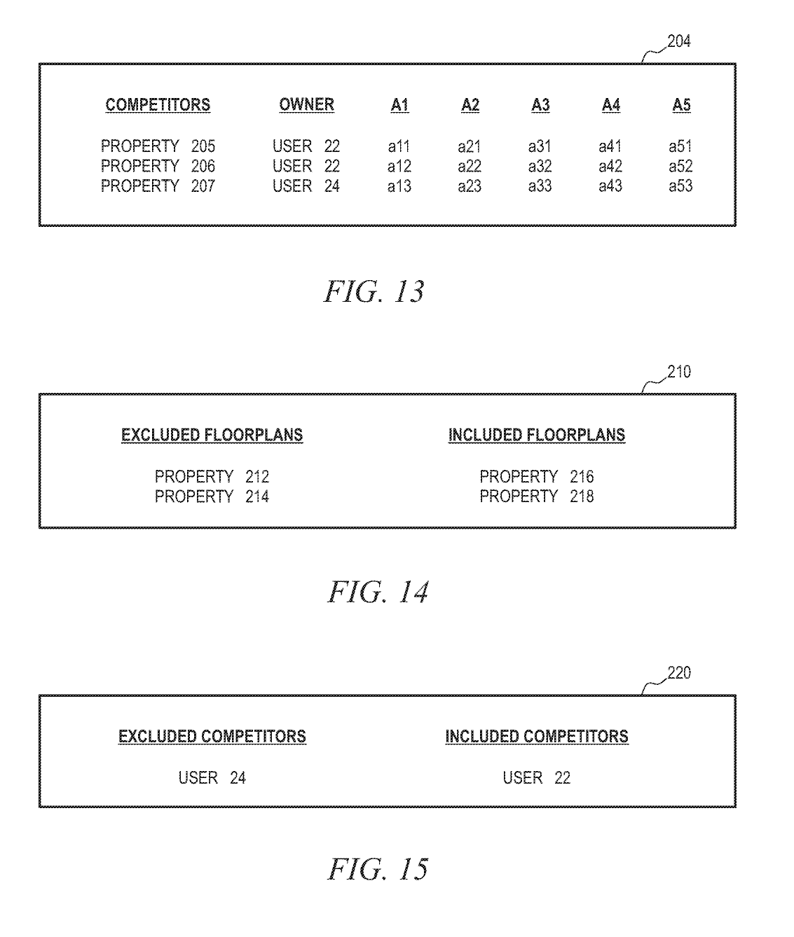

Users 20-24 can run reports to view the competitive analysis. Webpage 204 in FIG. 13 shows a report of competitor properties. Property 205 is owned by user 22, property 206 is owned by user 22, and property 207 is owned by users 24. Each property shows a number of attributes, which can be customized. Attributes include property information, such as floorplan, square footage, features, amenities, pricing, incentives, lease terms, traffic, leases, lease percentage, and occupancy. In one embodiment, attribute A1 is floorplan with values a11, a12, and a13 for properties 205, 206, and 207, respectively. Attribute A2 is features with values a21, a22, and a23 for properties 205, 206, and 207, respectively. Attribute A3 is pricing with values a31, a32, and a33 for properties 205, 206, and 207, respectively. Attribute A4 is incentives with values a41, a42, and a43 for properties 205, 206, and 207, respectively. Attribute A5 is occupancy with values a51, a52, and a53 for properties 205, 206, and 207, respectively.

The reports are customizable by selected one or more property information. For example, competitors and properties (units, floorplans) can be selected as included or excluded from a report. Webpage 210 in FIG. 14 shows excluded floorplans as properties 212 and 214 and included floorplans as properties 216 and 218. Webpage 220 in FIG. 15 shows excluded competitors as user 22 and included competitors as user 24. The report can include or exclude other competitor property information which may or may not compare accurately to the subject property.

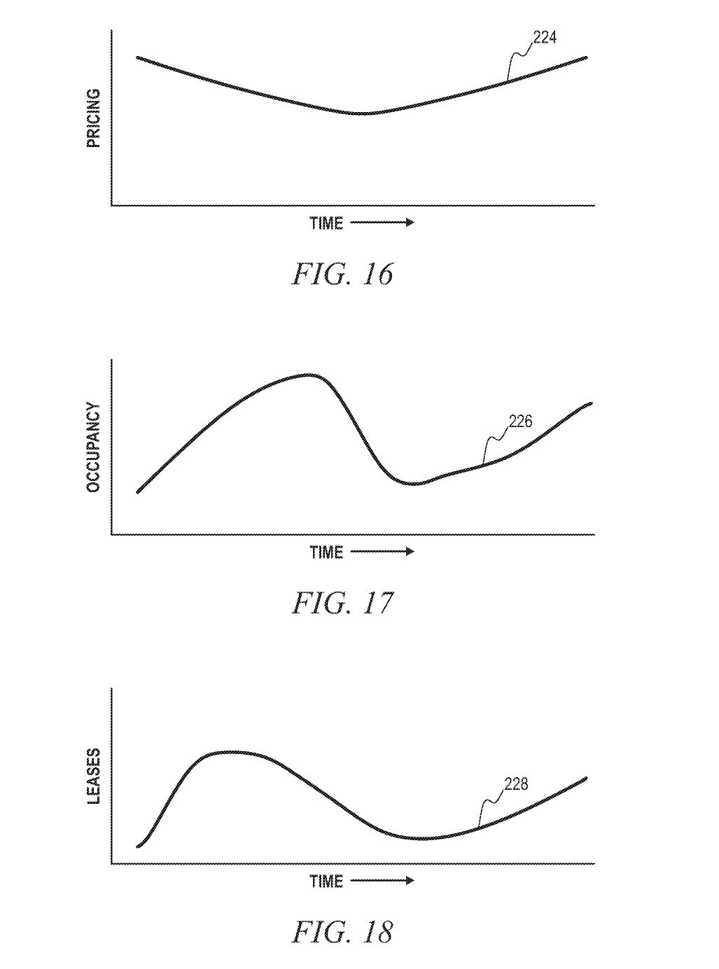

FIG. 16 is a report of a selected property, e.g., property 216 from user 22, as pricing line 224 over time. FIG. 17 is a report of a selected property, e.g., all properties of user 22, as occupancy line 226 over time. FIG. 18 is a report of a selected property, e.g., all properties of user 22, as leases line 228 over time. The time units can be daily, monthly, yearly, etc. Another type of report can be property rankings to ranks all unit types for the subject property and all comps and can be sorted by number of units, unit square footage, net effective rent (NER), or NER/SQFT. A market share report shows the percentage of each floor plan that every property making up the competitive environment controls. For example, users 20-24 can see which property has the highest number of a certain feature and compare against subject property or other comps. A community amenities report lists each property with community amenities and scoring for each property. Scoring or weighted averages provide a mechanism to rate the attributes. A location amenities report lists each property with location amenities and scoring for each property. A fees & deposits report lists fees and deposits for each property.

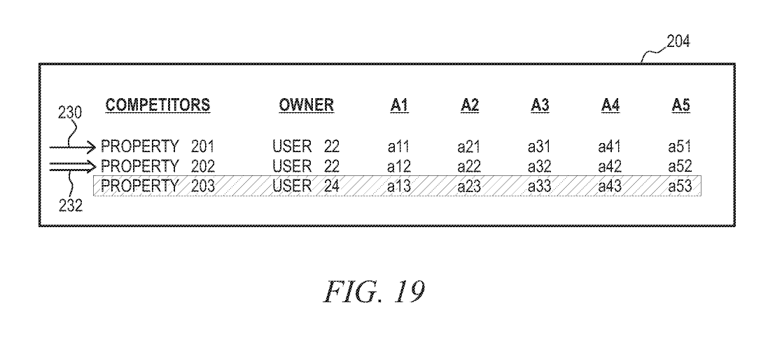

Electronic information exchange agent 12 performs data monitoring and reporting to maintain integrity of the system. If the data is outside statistical norms, e.g., pricing too high or too rapid a change in occupancy, then information exchange agent 12 flags the data as possible error. In FIG. 19, webpage 204 shows a report of competitor properties with arrow 230 identifying property 201 as a possible erroneous entry. Double arrow 232 indicates a higher level of suspicious data for property 202. The possibly erroneous data can be flagged by highlight, color codes, or other visual indicator, e.g., yellow indicates suspicious and red indicates highly improbable. Property 203 is shown highlighted, e.g., with color, to indicate possible erroneous entry. Suspicious data can be excluded from reporting and the user notified to confirm accuracy or correct an inaccuracy.

Electronic information exchange platform 28 is applicable to other industries. In the hotel industry, electronic information exchange platform 28 can be used to share information between hotel owners and chains. In the hotel case, the property information could be property name, property address, features (number of beds, type of beds), amenities, pricing, incentives, and occupancy. Other examples include storage, office space, airlines, rental cars, and other competitive businesses.

The process of information exchange transaction 190 or 196 using the organization of data structure 30 in database 14 simplifies the function and operation of computer system 10 by making property information, including confidential information, available among competitors. The market as a whole benefits from transparency in exchanging property information in a competitive environment. Information exchange transactions 190 and 196 benefits of users 20-24. User 26 can also benefit by access to the property information. Electronic information exchange agent 12 monitors and regulates the connection between users seeking to exchange information. The information exchange format provides an organized, accurate, and efficient operation of computer system 10, as well as communication network 60. Users make fewer searches and less demand on computing and network resources while gaining more timely and accurate information.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling communication over an electronic network to facilitate an exchange of information, comprising:
providing a database on a first computing system including a data structure to organize records for the exchange of information;
providing an electronic information exchange agent on the first computing system;
providing first property information from a first user on a second computing system to the electronic information exchange agent for storage in the data structure on the first computing system, wherein the first property information includes first confidential property information;
providing second property information from a second user on a third computing system to the electronic information exchange agent for storage in the data structure on the first computing system, wherein the second property information includes second confidential property information; and
exchanging of the first property information and the second property information between the first user and second user through the electronic information exchange agent.

2. The method of claim 1, wherein the first property information includes property description, property features, property amenities, price, and incentives.

3. The method of claim 1, wherein the first confidential property information includes tenant traffic, lease terms, leases, and occupancy.

4. The method of claim 1, wherein the first user and second user are competitors.

5. The method of claim 1, further including generating a report from the first property information or second property information.

6. The method of claim 1, further including automatically exchanging of the first property information and the second property information between the first user and second user.

7. A method of controlling communication over an electronic network to facilitate an exchange of information, comprising:
providing a database on a first computing system including a data structure to organize records for the exchange of information;
providing first property information from a first user on a second computing system to an electronic information exchange agent for storage in the data structure on the first computing system;
providing second property information from a second user on a third computing system to the electronic information exchange agent for storage in the data structure on the first computing system; and
exchanging of the first property information and the second property information between the first user and second user through the electronic information exchange agent.

8. The method of claim 7, wherein the first property information includes property description, property features, property amenities, price, and incentives.

9. The method of claim 7, wherein the first property information includes confidential property information.

10. The method of claim 9, wherein the confidential property information includes tenant traffic, lease terms, leases, and occupancy.

11. The method of claim 7, wherein the first user and second user are competitors.

12. The method of claim 7, further including generating a report from the first property information or second property information.

13. The method of claim 7, further including automatically exchanging of the first property information and the second property information between the first user and second user.

14. A non-transitory, tangible computer readable medium storing instructions for controlling communication over an electronic network, the instructions causing the electronic network to perform the steps, comprising:
providing a database on a first computing system including a data structure to organize records for the exchange of information;
providing first property information from a first user on a second computing system to an electronic information exchange agent for storage in the data structure on the first computing system;
providing second property information from a second user on a third computing system to the electronic information exchange agent for storage in the data structure on the first computing system; and
exchanging of the first property information and the second property information between the first user and second user through the electronic information exchange agent.

15. The non-transitory, tangible computer readable medium of claim 14, wherein the first property information includes property description, property features, property amenities, price, and incentives.

16. The non-transitory, tangible computer readable medium of claim 14, wherein the first property information includes confidential property information.

17. The non-transitory, tangible computer readable medium of claim 16, wherein the confidential property information includes tenant traffic, lease terms, leases, and occupancy.

18. The non-transitory, tangible computer readable medium of claim 14, wherein the first user and second user are competitors.

19. The non-transitory, tangible computer readable medium of claim 14, further including generating a report from the first property information or second property information.

20. The non-transitory, tangible computer readable medium of claim 14, further including automatically exchanging of the first property information and the second property information between the first user and second user.
